(19) United States
(12) Patent Application Publication
(10) Pub. No.: US 2012/0271756 A1
(43) Pub. Date: Oct. 25, 2012

(54) SEGMENTATION PROCESS AND DECISION MATRIX

(76) Inventor: CHRIS SAITTA, Rancho Palos Verdes, CA (US)

(21) Appl. No.: 13/092,517

(22) Filed: Apr. 22, 2011

(51) Int. Cl. G06Q 40/00

(52) U.S. Cl. 705/38

(57) ABSTRACT

Embodiments of the present invention provide a system and method for a segmentation decision engine to import and analyze asset data, comprising gathering asset and borrower related data for a selected asset from an asset contact, analyzing the asset and borrower related data for the asset, using proprietary modeling to predict a plurality of possible strategies based on the data, and selecting an optimal strategy from the plurality of possible strategies.

### TECHNICAL FIELD

The present invention relates generally to segmentation systems and methods, and more particularly, some embodiments relate to systems and methods for importing asset data and analyzing the data using a segmentation decision engine.

### BRIEF SUMMARY OF EMBODIMENTS OF THE INVENTION

Embodiments of the present invention provide systems and processes for the automated or manual import of asset data (e.g., property data), which is then analyzed using a segmentation decision engine. In some cases, the analysis results in determining initial program eligibilities and potential strategies. Once imported, a borrower solicitation module is activated, which allows for automated user workflow to gather additional asset and borrower elated data from the best asset contact, in an effort to further decision the asset to the correct disposition. This ultimately results in the asset being automatically transferred into the appropriate application for further processing.

According to some embodiments, a segmentation application may provide for three different methods of asset import including (i) agent, (ii) client internal, and (iii) bulk internal. In one implementation, a strict validation process consisting of data integrity and duplication checks is executed to determine if the asset is eligible for import into the segmentation application. Upon successful import, a comprehensive segmentation configurable user decision engine (SCUDE) can be employed to analyze all the data that has been provided for the specific asset. In addition, the SCUDE may be used to set multiple values based on the results of the decisions, such as different program eligibilities (e.g., government programs such as HAFA (Home Affordable Foreclosure Alternatives) or client internal programs), disposition strategy, and other values that allow for workload distribution. In some cases, assets can also be initiated/imported by borrowers.

Once initial decisions and values have been set, tasking is assigned to begin the borrower solicitation piece of the segmentation application. In some embodiments, this tasking is distributed to a solicitation specialist via a work queue assignment matrix to allow for a pool of users to work a group of similar tasks. After successful contact with the borrower during solicitation, additional information may be gathered to make an updated assessment of the asset's situation and the borrower's eligibilities. The rules engine is again engaged and the asset's data is analyzed, finalizing the decisions and disposition strategy. Once the final decisions have been made, the asset can be automatically transferred from the segmentation application to the appropriate application that will handle the determined disposition.

In addition to the above described workflow, some embodiments of the invention feature a sophisticated administrative area for approved users to configure everything from basic application settings to assigning/creating user privileges/task pools/workgroups either individually or in bulk. Such settings may be used to configure all rules regarding first and second pass decisioning and setting eligibilities.

One embodiment of the invention comprises a method for a segmentation decision engine to import and analyze asset data, comprising gathering asset and borrower related data for a selected asset from an asset contact, analyzing the asset and borrower related data for the asset, using proprietary modeling to predict a plurality of possible strategies based on the data, and selecting an optimal strategy from the plurality of possible strategies.

The above method may further comprise performing a data validation function and importing ad hoc information from a prior strategy. In some cases, this segmentation process may be employed in a loan default setting, and the possible strategies may comprise loan modification, short sale, and foreclosure strategies. In addition, some embodiments may include: (i) a borrower contact component for attempting to contact the borrower; and/or (ii) a borrower outreach component for gathering additional asset and borrower related data such that the segmentation decision engine can make an updated assessment of the asset and eligibilities of the borrower.

In some embodiments, the method also comprises evaluating a plurality of strategies in terms of compliance and calculating a score representing each strategy in order to predict the optimal strategy based upon the highest score. The asset and borrower related data that is gathered by the segmentation decision engine may include delinquent loan data, analytics, data from questionnaires, and third party data. Additional steps may entail determining a loss mitigation strategy based on the selected optimal strategy, and automatically transferring the asset to an appropriate application for handling the selected optimal strategy.

Further embodiments of the invention involve a system for a segmentation decision engine importing and analyzing asset data, comprising: a processor; and at least one computer program residing on the processor; wherein the computer program is stored on a non-transitory computer readable medium having computer executable program code embodied thereon, the computer executable program code configured to cause the segmentation decision engine to: gather asset and borrower related data for a selected asset from an asset contact; analyze the asset and borrower elated data for the asset; use proprietary modeling to predict a plurality of possible strategies based on the data; and select an optimal strategy from the plurality of possible strategies.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings a provided to facilitate the reader's understanding of the invention and shall not be considered limiting of the breadth, scope, or applicability of the invention. It should be noted that for clarity and ease of illustration these drawings are not necessarily made to scale.

FIGS. 1A-1C are flowcharts depicting an optimum segmentation module and process of segmentation decision engine, in accordance with an embodiment of the invention.

FIG. 2 is a diagram illustrating an example computing module for implementing various embodiments of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

Embodiments of the present invention are directed toward systems and methods for importing asset data (e.g., property data) and analyzing the data using a segmentation decision engine in order to determine initial program eligibilities and potential strategies. Once imported, a borrower solicitation module is activated, which allows for automated user workflow to gather additional asset and borrower related data from the best asset contact, in an effort to further decision the asset to the correct disposition. This ultimately results in the asset being automatically transferred into the appropriate application for further processing. The functionality of the segmentation decision engine may be based upon one or more segmentation applications residing on the engine and comprising a decision matrix.

The segmentation process can be used to identify the proper path or process to be taken by an account manager. In some embodiments, the process may be used in a loan default setting, wherein various information is input into the segmentation decision engine and proprietary modeling is used to predict an optimal loan outcome (i.e., best case scenario) based on the input data. This may also entail evaluating each scenario in terms of compliance and calculating a score representing each scenario. The input data may include delinquent loan data, analytics, data from questionnaires, third party data and other information that tends to drive loan behavior.

In other embodiments, the segmentation process is employed in a real estate setting, wherein asset data, real estate agent information, analytics and other information is input into the segmentation decision engine and proprietary modeling is used to evaluate various strategies and determine an optimal strategy in view of the input data. Each evaluated strategy is provided with a corresponding score, wherein the optimal strategy has the highest score. The proprietary modeling may entail the client choosing a marketing path, which prompts the search engine to display client configurable default base rules that may be selectively altered by the client.

Asset Import

According to one embodiment of the invention, the segmentation application provides for three different methods of asset import, specifically: (i) agent; (ii) client internal; and (iii) bulk internal. In some cases, a strict validation process consisting of data integrity and duplication checks is executed to determine the asset is eligible for import into the segmentation application. This data integrity check can include reviewing all incoming values for: (i) proper data type; (ii) acceptable values; and (iii) client specific data elements. The duplication check ensures that all assets that have had prior decisioning are re-decisioned efficiently utilizing all available data.

Initial Segmentation Decision

Upon successful import, a comprehensive user configurable decision engine analyzes all the data that has been provided for a specific asset and generates an initial strategy decision. The rules utilized in the initial decision making are fully configurable by the servicer utilizing the tool. Such rules may include, but are not limited to various data elements such as global reference values such as Asset Investor, NPV, Asset Type, Value, UPB, Number of Units, etc. The decision engine reviews all available rules and data elements, and determines an optimal initial strategy. This strategy can be chosen by elimination, waterfall selection, client specific scoring or attribute sorting methods. The decision engine allows the creation of unique rule sets for different investors, asset types, geography, and other client configured bifurcations. Along with the selection of the optimal initial strategy, the decision engine can also create an asset snapshot of all the data elements utilized in the decision making, the results of each individual rule, and strategy eligibility results.

Borrower Solicitation

In some cases, once initial decisions and values have been set, the system may make a determination that borrower contact is required to obtain borrower buy-in and additional information. When borrower contact is necessary, the system may utilize the borrower solicitation module. Borrower solicitation enables the creation of multiple work queues to distribute outgoing calls to a wide variety of internal and external user groups.

Clients control a matrix determining the allowable workgroups and the priority of the items within the workgroups. In some embodiments, priorities can be set on attributes including without (i) Age; (ii) Asset Value; Strategy Type; (iv) Investor; and (v) additional client specific values. Call distribution can also be controlled based on language spoken and time of day at the asset location. All contact attempts may be tracked by the system and noted back to the call center during future contact attempts. Upon a successful contact attempt, the system walks the caller through a series of borrower and financial questions generated by the system. The specific questions asked of the borrower and order of the questions can be systematically determined based on multiple factors including, but not limited to: (i) prior answer response; (ii) investor; (iii) initial strategy decision; (iv) geography; and (v) client specific attributes.

Subsequent Segmentation Decisions

After successful contact with the borrower during solicitation, additional information can be gathered to make an updated assessment of the asset's situation and borrower's eligibilities. According to some embodiments, the decision engine (as described above) is utilized and the asset's data is analyzed in order to finalize the decisions and loss mitigation strategy. Once the final decisions have been made, the asset is automatically transferred from the segmentation application to the appropriate application for handling the determined strategy.

Administrative Functions

Some embodiments of the present invention include a sophisticated administrative area for approved users to configure various items. These items may include, but are not limited to: (i) security settings; (ii) assignment of user privileges, workgroups and roles; (iii) configuration of all rules; (iv) configuration of NPV assumptions; and (v) communications.

Optimum Segmentation Module and Process

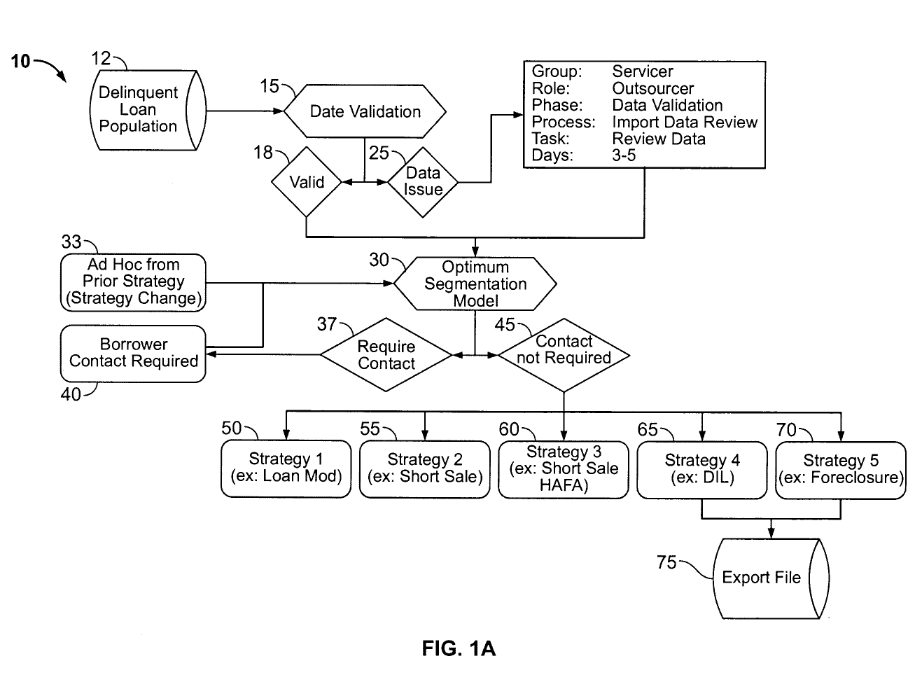

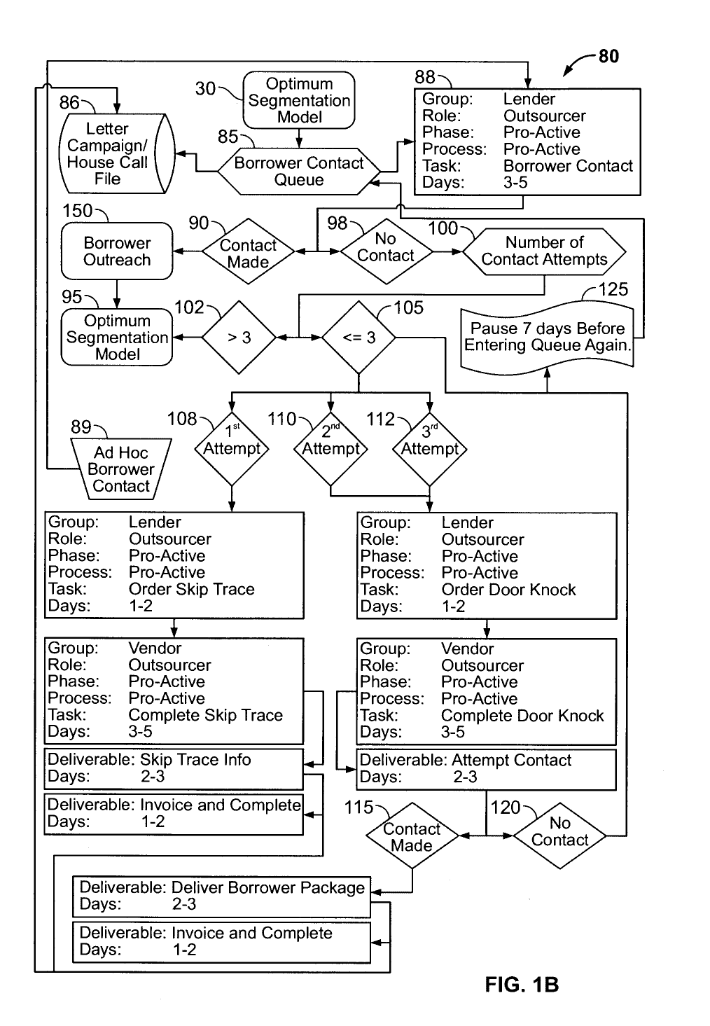

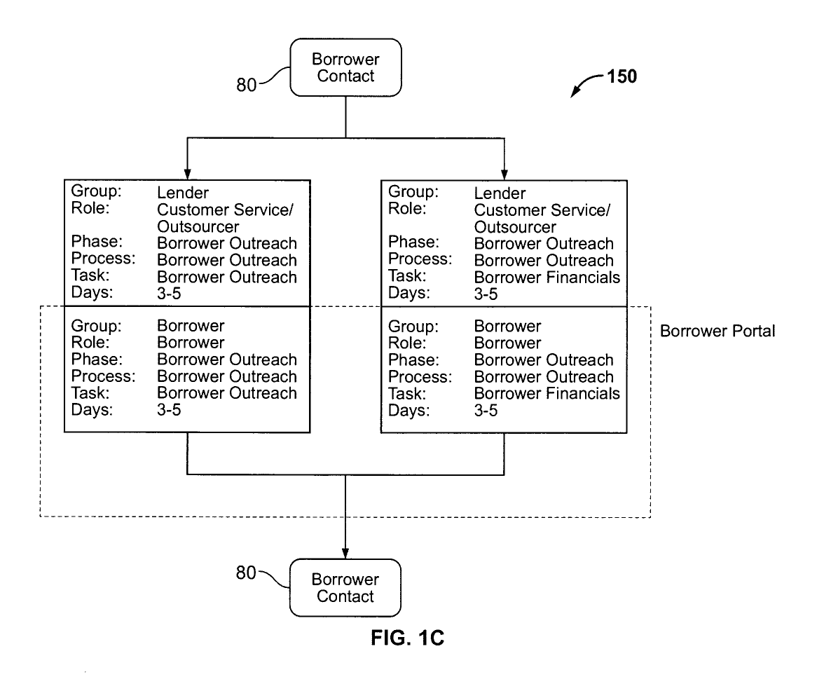

FIGS. 1A-1C are flowcharts depicting an optimum segmentation module and process of the segmentation decision engine, in accordance with an embodiment of the invention. Specifically, FIG. 1A illustrates strategy decisioning component 10 of the segmentation module, whereas FIG. 1B illustrates borrower contact component 80 and FIG. 1C illustrates borrower outreach component 150. This particular embodiment involves a loan default setting, wherein various information is input into the segmentation decision engine and proprietary modeling is used to predict an optimal loan outcome based on the input data. Other embodiments of the invention involve other settings, e.g., real estate settings, etc.

Referring now to FIG. 1A depicting strategy decisioning component 10, delinquent loan population 1 is provided as an input to data validation 15. Operation 18 involves verifying that the loan is valid, while operation 25 involves reviewing data and identifying/resolving any data issues. The loan information and data is then provided to the optimum segmentation model 30. In operation 33, ad hoc information is imported from a prior strategy. If borrower contact is required (operation 37), then the process proceeds to operation 40 (borrower contact required, see FIG. 1B). Any information obtained through borrower contact is provided to the optimum segmentation module 30. In a case where borrower contact is not required (operation 45), the engine proceeds to select a suitable strategy for achieving the optimal loan outcome. In the illustrated embodiment, the strategies include: Strategy 1—Loan Mod (50); Strategy 2—Short Sale (55); Strategy 3—Short Sale HAFA (60); Strategy 4—DIL (65); and Strategy 5—Foreclosure (70). Operation 75 entails exporting the file.

Referring now to FIG. 1B depicting borrower contact component 80, if borrower contact is required in accordance with the optimum segmentation model 30, loan information is input into borrower contact queue 85. In some cases, contact with the borrower can be made via a letter campaign or house call file (operation 86). In operation 88, contact is attempted with the borrower, optionally using ad hoc borrower contact information (operation 89). If contact is made (operation 90), the process proceeds to operation 150, the borrower outreach component of the segmentation module (see FIG. 1C), and then to operation 95, the optimum segmentation model 30 (see FIG. 1A). If no contact is made (operation 98), the number of contact attempts is provided in operation 100.

With further reference to FIG. 1B, if contact is not made on more than three attempts (operation 102), the process proceeds to operation 95, the optimum segmentation model 30 (see FIG. 1A). However, contact may be made within three attempts (operation 105) including on the first attempt 108, second attempt 110 or third attempt 112. The first attempt 108 may entail ordering a skip trace operation, and completing and invoicing the borrower package. The second and third attempts 110, 112 may entail ordering and completing a door knock operation, and if contact is made (operation 115), delivering, completing and invoicing the borrower package. If no contact is made (operation 120), the loan file is paused for seven days (operation 125) before re-entering the borrower contact queue 85.

FIG. 1C depicts borrower outreach component 150, which is accessed via borrower contact component 80. In particular, the borrower outreach component 150 includes a borrower outreach segment 155 and a borrower financial segment 160. Some data within these segments 155, 160 may only be available through use of borrower portal 165.

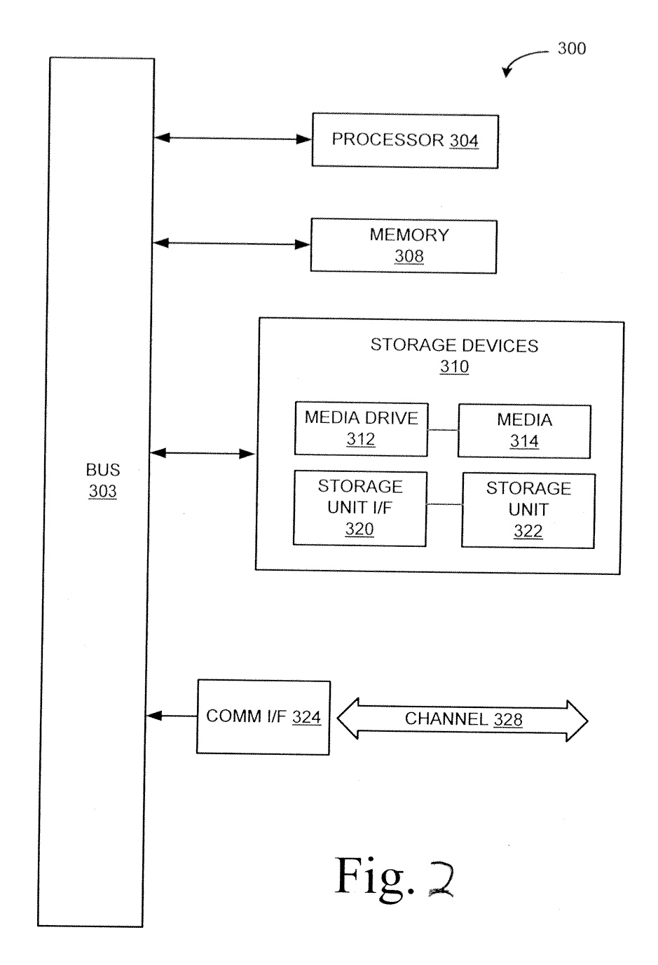

As used herein, the term “module” might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 2. Various embodiments are described in terms of this example-computing module 300. After reading this description, it will become apparent to a person skilled in the relevant art how to implement the invention using other computing modules or architectures.

Referring now to FIG. 2, computing module 300 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 300 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 300 might include, for example, one or more processors, controllers, control modules, or other processing devices, such as a processor 304. Processor 304 might be implemented using a general-purpose or special-purpose processing engine such as, for example, a microprocessor, controller, or other control logic. In the illustrated example, processor 304 is connected to a bus 303, although any communication medium can be used to facilitate interaction with other components of computing module 300 or to communicate externally.

Computing module 300 might also include one or more memory modules, simply referred to herein as main memory 308. For example, preferably random access memory (RAM) or other dynamic memory, might be used for storing information and instructions to be executed by processor 304. Main memory 308 might also be used for storing temporary variables or other intermediate information during execution of instructions to be executed by processor 304. Computing module 300 might likewise include a read only memory (“ROM”) or other static storage device coupled to bus 303 for storing static information and instructions for processor 304.

The computing module 300 might also include one or more various forms of information storage mechanism 310, which might include, for example, a media drive 312 and a storage unit interface 320. The media drive 312 might include a drive or other mechanism o support fixed or removable storage media 314. For example, a hard disk drive, a floppy disk drive, a magnetic tape drive, an optical disk drive, a CD, DVD or Blu-ray drive (R or RW), or other removable or fixed media drive might be provided. Accordingly, storage media 314 might include, for example, a hard disk, a floppy disk, magnetic tape, cartridge, optical disk, a CD, DVD or Blu-ray, or other fixed or removable medium that is read by, written to or accessed by media drive 312. As these examples illustrate, the storage media 314 can include a computer usable storage medium having stored therein computer software or data.

In alternative embodiments, information storage mechanism 310 might include other similar instrumentalities for allowing computer programs or other instructions or data to be loaded into computing module 300. Such instrumentalities might include, for example, a fixed or removable storage unit 322 and an interface 320. Examples of such storage units 322 and interfaces 320 can include a program cartridge and cartridge interface, a removable memory (for example, a flash memory or other removable memory module) and memory slot, a PCMCIA slot and card, and other fixed or removable storage units 322 and interfaces 320 that allow software and data to be transferred from the storage unit 322 to computing module 300.

Computing module 300 might also include a communications interface 324. Communications interface 324 might be used to allow software and data to be transferred between computing module 300 and external devices, Examples of communications interface 324 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 might typically be carried on signals, which can be electronic, electromagnetic (which includes optical) or other signals capable of being exchanged by a given communications interface 324. These signals might be provided to communications interface 324 via a channel 328. This channel 328 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” “computer usable medium” are used to generally refer to media such as, for example, memory 308, storage unit 320, media 314, and channel 328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 300 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A system for a segmentation decision engine importing and analyzing asset data, comprising:
a processor; and
at least one computer program residing on the processor;
wherein the computer program is stored on a non-transitory computer readable medium having computer executable program code embodied thereon, the computer executable program code configured to cause the segmentation decision engine to:
gather asset and borrower related data for a selected asset from an asset contact;
analyze the asset and borrower related data for the asset;
use proprietary modeling to predict a plurality of possible strategies based on the data; and
select an optimal strategy from the plurality of possible strategies.

2. The system of claim 1, wherein the segmentation decision engine performs a data validation function.

3. The system of claim 2, wherein the segmentation decision engine imports ad hoc information from a prior strategy.

4. The system of claim , wherein the segmentation process is employed in a loan default setting, and wherein the possible strategies comprise loan modification, short sale, and foreclosure strategies.

5. The system of claim 1, further comprising a borrower contact component for attempting to contact the borrower.

6. The system of claim 1, further comprising a borrower outreach component for gathering additional asset and borrower related data such that the segmentation decision engine can make an updated assessment of the asset and eligibilities of the borrower.

7. The system of claim 1, wherein the segmentation decision engine is configured to evaluate a plurality of strategies in terms of compliance and calculate a score representing each strategy in order to predict the optimal strategy based upon the highest score.

8. The system of claim 1, wherein the asset and borrower related data that is gathered by the segmentation decision engine includes delinquent loan data, analytics, data from questionnaires, and third party data.

9. The system of claim 1, wherein the segmentation decision engine is further configured to determine a loss mitigation strategy based on the selected optimal strategy.

10. The system of claim 1, wherein the segmentation decision engine is further configured to automatically transfer the asset to an appropriate application for handling the selected optimal strategy.

11. A method for a segmentation decision engine to import and analyze asset data, comprising:
gathering asset and borrower related data for a selected asset from an asset contact;
analyzing the asset and borrower related data for the asset;
using proprietary modeling to predict a plurality of possible strategies based on the data; and
selecting an optimal strategy from the plurality of possible strategies,

12. The method of claim 11, further comprising performing a data validation function.

13. The method of claim 12, further comprising importing ad hoc information from a prior strategy.

14. The method of claim 11, wherein the segmentation process is employed in a loan default setting, and wherein the possible strategies comprise loan modification, short sale, and foreclosure strategies.

15. The method of claim 11, further comprising providing a borrower contact component for attempting to contact the borrower.

16. The method of claim 11, further comprising providing a borrower outreach component for gathering additional asset and borrower related data such that the segmentation decision engine can make an updated assessment of the asset and eligibilities of the borrower.

17. The method of claim 11, further comprising evaluating a plurality of strategies in terms of compliance and calculating a score representing each strategy in order to predict the optimal strategy based upon the highest score.

18. The method of claim 11, wherein the asset and borrower related data that is gathered by the segmentation decision engine includes delinquent loan data, analytics, data from questionnaires, and third party data.

19. The method of claim 11, further comprising determining a loss mitigation strategy based on the selected optimal strategy.

20. The method of claim 1, further comprising automatically transferring the asset to an appropriate application for handling the selected optimal strategy.
